(19) United States
(12) Patent Application Publication
(10) Pub. No.: US 2007/0247360 A1
(43) Pub. Date: Oct. 25, 2007

(54) Global positioning system receiver capable of simultaneously receiving global positioning system signal and frequency modulation sub-wave signal

(75) Inventor: Hsin-Chih Hsu, Hsinchu (TW)

Correspondence Address: BACON & THOMAS, PLLC, 625 SLATERS LANE, FOURTH FLOOR, ALEXANDRIA, VA, 22314, US

(73) Assignee: Jabil Circuit Taiwan Limited, Hsinchu (TW)

(21) Appl. No.: 11/242,833

(22) Filed: Oct. 5, 2005

(30) Foreign Application Priority Data
Jul. 8, 2005 (TW) 094211618

(51) Int. Cl. G01S 5/14

(52) U.S. Cl. 342/357.09

(57) ABSTRACT

A global positioning system (GPS) receiver capable of simultaneously receiving a global positioning system signal and a frequency modulation sub-wave signal includes two antennas, one for receiving a GPS signal and the other for receiving a frequency modulation (FM) sub-wave signal such that these signals are computed and resolved by a hardware interface, and sent to an electronic device connected with the hardware interface. The electronic device can simultaneously read a positioning coordinate data and a TMC data, so that an electronic map, a navigation system or other GPS software installed in the electronic device can accurately position a current position and provide the traffic conditions of the current position, so that a user can know about the road conditions, plan a path, and decide the best traveling path.

### FIELD OF THE INVENTION

The present invention relates to a global positioning system (GPS) receiver, more particularly to a GPS receiver capable of simultaneously receiving GPS signal and frequency modulation (FM) sub-wave signal, resolving the positioning coordinates data and traffic message channel (TMC) data contained therein, and providing the same to an electronic device connected with the GPS receiver for identifying and analyzing the current position and the traffic conditions for a user to decide the best traveling path.

### BACKGROUND OF THE INVENTION

In the recent decade, transportations and communications become increasingly convenient, and the scope of human activities expands gradually to all places over the world. However, a way of accurately positioning the location of a person or an object in such extensive activity space and complicated transportation and communication network depends on the development of technological industries. A device named global positioning system (GPS) can accurately position the coordinates of a person or an object by receiving a signal transmitted from a satellite, so that a user can perform various activities (such as positioning, investigating, tracking and researching, etc) by using an electronic map or other navigation system software according to the foregoing coordinates. In such extensive area, users can master the path and scope of a specific person or object, and thus effectively eliminating trouble as well as reducing the waste of manpower, time and resources due to the unknown position of a person or an object.

Referring to FIG. 1 for a prior art global positioning system, the GPS comprises a computer system 10 (such as a palmtop or a notebook computer) installing a global positioning system related software therein, and the computer system 10 installs a GPS receiver 20 having an antenna 30 for receiving a coordinates information transmitted from a satellite to analyze and determine the coordinates of the user's position, and the related software accurately computes the geological position and display such information on a screen of the computer system 10 for the user's reference, so that users can know about the road conditions and the planned path.

The related circuit of the prior art GPS receiver 20 is installed a housing 21 having a PCMCIA interface or a CF interface. Referring to FIG. 1 again, the receiver 20 has a terminal (not shown in the figure) at an end to be inserted into the PCMCIA interface or CF interface slot 11 of the computer system 10, and the other end is connected to a GPS antenna 30 by a cable 23. If a user uses such GPS outdoors, the user needs to place the external antenna 30 on one hand1, and operate the related software of the computer system 10 by the other hand to process and compute the geological position of the user according to the received current position signal.

Since the GPS receiver 20 or the related software cannot obtain instant information about the traffic conditions of the user's position, therefore the user may misjudge the actual traffic conditions and may get stuck in a traffic jam as in a dilemma. Therefore, a way of designing a GPS receiver that provides the coordinates of the current position and the instant traffic information for an electronic device to analyze the traffic conditions of the current position and for a user to determine the best traveling path becomes an important subject for GPS receiver designers and manufacturers to overcome.

### SUMMARY OF THE INVENTION

In view of the description above, the inventor of the present invention based on years of experience to conduct extensive researches and experiments to improve the functions of the prior art GPS receiver, and finally invented a global positioning system receiver capable of simultaneously receiving global positioning system signal and frequency modulation sub-wave signal in accordance with the present invention. The receiver comprises two antennas, wherein a first antenna is used for receiving a GPS signal and sending the GPS signal to a GPS radio frequency (RF) circuit. The GPS radio frequency circuit amplifies, down-converts, and digitizes the GPS signal and then sends the signal to a GPS base band processor (BBP). After the GPS base band processor de-spreads and synchronizes the signal, the signal is sent to a microprocessor, and the microprocessor performs a positioning coordinate computation to the GPS signal. The second antenna is used to receive a frequency modulation (FM) sub-wave signal and send the FM sub-wave signal to a FM tuner. The FM tuner amplifies and demodulates the FM sub-wave signal to a FM sub-wave signal with a specific frequency (such as 57 KHz). The FM sub-wave signal is sent to a preprocessor, and after the preprocessor synchronizes a block data in the FM sub-wave, the FM sub-wave signal is sent to the microprocessor again, and the microprocessor resolves the block data of the FM sub-wave into traffic message channel (TMC) data. In the meantime, the positioning coordinates and the TMC data are computed and resolved by a hardware interface and then sent to an electronic device connected to the hardware interface, such that the electronic device can simultaneously read the positioning coordinates data and the TMC data, and an electronic map, a navigation system or other GPS software installed in the electronic device accurately positions the current position and the traffic conditions of the current position for user's reference, so that a user can know about the road conditions and plan a path and decide the best traveling path.

The above and other objects, features and advantages of the present invention will become apparent from the following detailed description taken with the accompanying drawings.

### BRIEF DESCRIPTION OF THE DRAWINGS

FIG. 1 is a schematic view of a prior art global positioning system; and

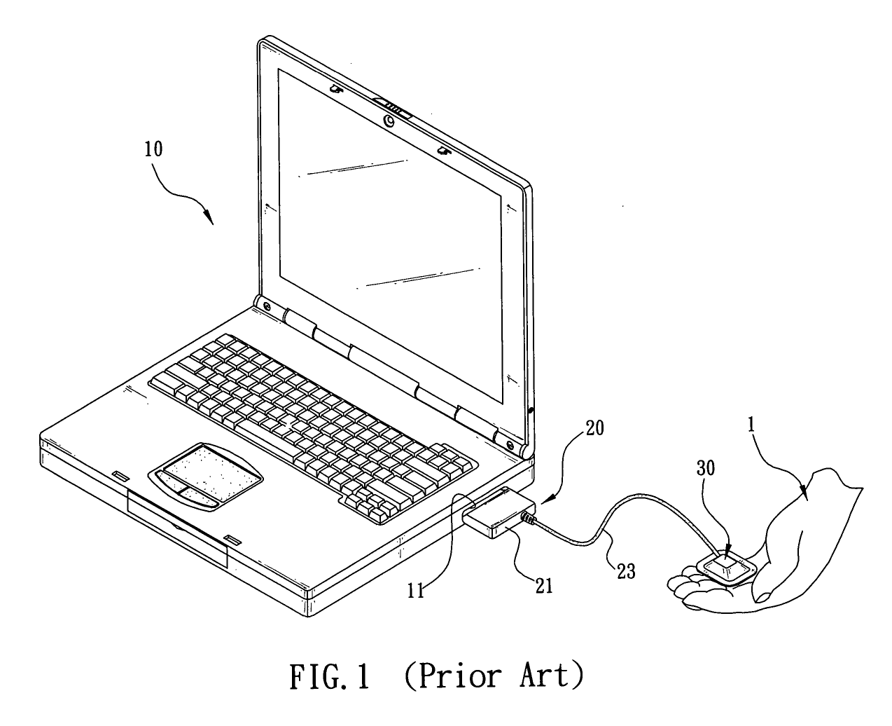

FIG. 2 is a schematic view of a circuit connection between a global positioning system and an electronic device according to a preferred embodiment of the present invention.

### DETAILED DESCRIPTION OF THE PREFERRED EMBODIMENTS

The present frequency modulation broadcasting (FM broadcasting) occupies a bandwidth of 200 KHz, wherein a single-sided bandwidth occupies 100 KHz and a general stereo main carrier wave only occupies about 53 KHz bandwidth of a single-sided bandwidth for transmitting analog music and voice programs, and the rest 47 KHz is used for other applications. The standard communication system that uses an available secondary channel of the present frequency modulation broadcasting as analog or digital transmissions is called a “FM Sub-wave System” which coexists with the main carrier wave while transmitting other messages without affecting the transmission of the main carrier wave program.

Among various FM sub-wave systems, a FM sub-wave having a center frequency of 57 KHz, a bandwidth of 4 KHz and a data transmission rate of 1200 bps is called a radio data system (RDS) FM sub-wave system. The RDS FM sub-wave system is extensively used for transmitting data and information, particularly for transmitting traffic message channel (TMC) data. The TMC data comprises traffic information such as an event, a place, a start time, a stop time, an average speed, an affected length, and a diverse advise route, etc. The traffic authority uses the RDS FM sub-wave system to encode and send out the corresponding traffic information to be received by a FM receiver (such as a FM radio) within an effective range, and each of the FM receivers decodes the corresponding coded textual information and display the textual information in form of a marquee on a display device (such as a liquid crystal display panel) for user's reference. Such arrangement provides instant traffic information without affecting the normal operations of music and voice programs.

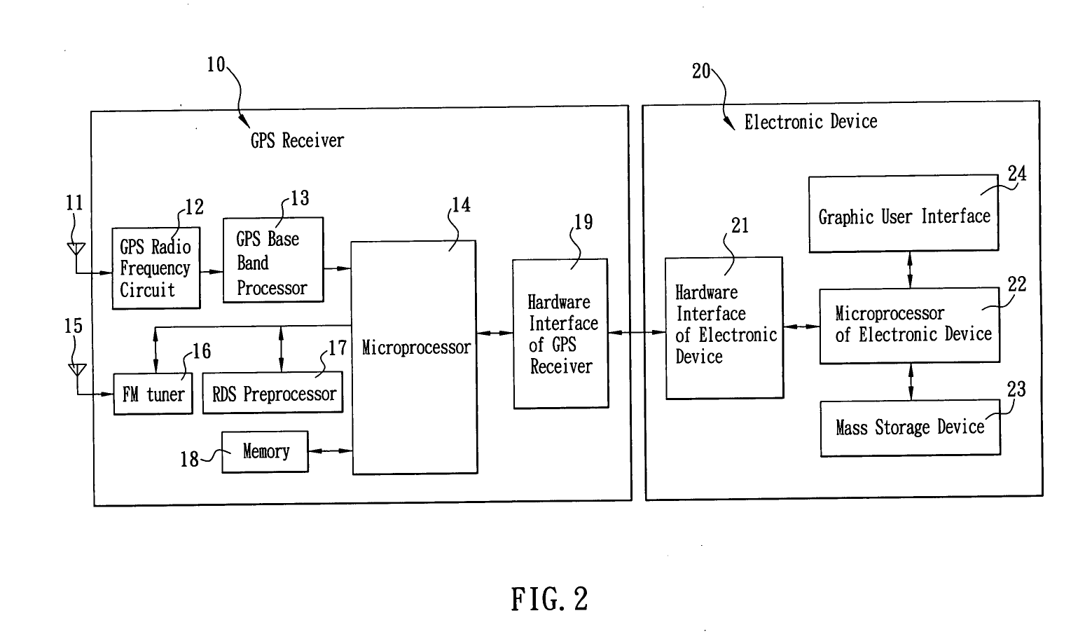

Based on the foregoing concept, the present invention designs a global positioning system receiver capable of simultaneously receiving global positioning system signal and frequency modulation sub-wave signal. Referring to FIG. 2 for the preferred embodiment of the present invention, the receiver 10 comprises a first antenna 11 and a second antenna 15; wherein the first antenna 11 is used for receiving a GPS signal and sending the GPS signal to a GPS radio frequency circuit 12. The GPS radio frequency circuit 12 amplifies, down-converts, and digitizes the GPS signal, and then sends the GPS signal to a GPS base band processor 13. After the GPS base band processor 13 de-spreads and synchronizes the GPS signal, the signal is sent to a microprocessor 14, and the microprocessor 14 computes the positioning coordinates of the GPS signal. The second antenna 15 is used for receiving a FM sub-wave signal, and sending the FM sub-wave signal to a FM tuner 16. The FM tuner 16 amplifies and demodulates the FM sub-wave signal and then resolves the signal into a FM sub-wave having a center frequency of 57 KHz, a bandwidth of 4 KHz and a data transmission rate of 1200 bps. The RDS FM sub-wave signal is sent to a RDS preprocessor 17, and after the preprocessor 17 synchronizes a block data in the RDS FM sub-wave, the FM sub-wave signal is sent to the microprocessor 14. The microprocessor 14 resolves the block data in the RDS FM sub-wave signal into a TMC data, and a hardware interface 19 of the receiver 10 sends out the computed and resolved positioning coordinates data and TMC data at the same time for an electronic device 20 connected to the hardware interface 19 of the receiver 10 to identify and analyze the traffic conditions of the current position.

It is noteworthy that the FM sub-wave received by the receiver 10 according to this embodiment is not limited to the FM sub-wave system of a RDS, but it could be a FM sub-wave system having other frequencies, as long as the FM sub-wave of each frequency is used for transmitting the codes of instant traffic information such as an event, a place, a start time, a stop time, an average speed, an affected length, and a diverse advise route, etc. After the receiver 10 receives the codes, the codes are resolved into TMC data, and the TMC data is sent to the electronic device 20. With the identified current position, the traffic conditions of the current position are analyzed. The foregoing description gives the definition of “FM sub-wave” used in the present invention.

In this preferred embodiment, the receiver 10 further comprises a memory 18 coupled to the microprocessor 14 for storing a program required by the microprocessor 14 to compute the positioning coordinates of the GPS signal and the coding rules required by the microprocessor 14 to resolve the block data in the FM sub-wave, such as the TMC traffic information and its corresponding codes of an event, a place, a start time, a stop time, an average speed, an affected length, and a diverse advise route. Therefore, the present invention only needs a single microprocessor 14 that executes and reads the computation programs and coding rules stored in the memory 18 to complete the computation of the positioning coordinates data and the resolution of the TMC data and then forms and sends out a text string. In the preferred embodiment, the text string is sent out in the form of ASCII, but the invention is not limited to ASCII only. The text string, depending on the realistic needs, can be sent in any other format instead.

In the present invention, the block data of the FM sub-wave decoded and down-converted into a resolution job for the electronic device 20 to read TMC data is completely accomplished by the receiver 10. After the electronic device 20 reads the positioning coordinates data and TMC data at the same time, an electronic map, a navigation system or other GPS software installed in the electronic device is used to quickly and accurately position the current position and the traffic conditions of the current position for a user's reference to know about the road conditions, plan the path, and decide the best traveling path.

In this preferred embodiment, the electronic device 20 includes a hardware interface 21 for electrically connecting the hardware interface 19 of the receiver 10, so that the electronic device 20 receives the positioning coordinate data and TMC data transmitted from the microprocessor 14 or sends a control instruction to the microprocessor 14 through the hardware interfaces 21, 19. If a microprocessor 22 installed on the electronic device 20 receives a positioning coordinates data and a TMC data transmitted from the receiver 10, the electronic device 20 reads the positioning coordinate data and uses an electronic map, a navigation system or other GPS software stored in a mass storage device 23 to accurately position the current position, and then indicate the traffic information such as an event, a place, a start time, a stop time, an average speed, an affected length, and a diverse advise route of the current position according to the TMC data to plan the path and find the best traveling path. The path can be displayed by a graphic user interface 24 of the electronic device 20 for reference.

It is worth to point out that although the hardware interfaces 21, 19 are connected to the electronic device 20 and the receiver 10 by a cable according to this preferred embodiment for transmitting data and instructions, yet other embodiments of the present invention are not limited to the connection by cables only. In actual practice, any wireless practice can be used for transmitting data or instruction to each other. Therefore, the hardware interfaces 21, 19 according to the preferred embodiment of the present invention include the hardware interfaces required for transmissions via cable or wireless transmissions. For wireless transmissions, each hardware interface 21, 19 further comprises a wireless communication module and related software.

While the invention has been described by means of specific embodiments, numerous modifications and variations could be made thereto by those skilled in the art without departing from the scope and spirit of the invention set forth in the following claims.

10 GPS Receiver

12 GPS Radio Frequency Circuit

13 GPS Base Band Processor

14 Microprocessor

16 FM tuner

17 RDS Preprocessor

18 Memory

19 Hardware Interface of GPS Receiver

20 Electronic Device

21 Hardware Interface of Electronic Device

22 Microprocessor of Electronic Device

23 Mass Storage Device

24 Graphic User Interface

What is claimed is:

1. A global positioning system receiver capable of simultaneously receiving global positioning system signal and frequency modulation sub-wave signal, comprising:
a global positioning system (GPS) signal receiving and processing circuit, for receiving a global positioning system signal and processing said global positioning system signal;
a frequency modulation sub-wave signal receiving and processing circuit, for receiving a frequency modulation sub-wave signal and processing said frequency modulation sub-wave signal;
a microprocessor, for receiving a signal transmitted from said global positioning system signal receiving and processing circuit and computing a corresponding positioning coordinate data, and for receiving a data transmitted from said frequency modulation sub-wave signal receiving and processing circuit and resolving said signal and data into a traffic message channel (TMC) data; and
a hardware interface, for receiving said positioning coordinate data and said traffic message channel data transmitted from said microprocessor and simultaneously transmitting said data out.

2. The receiver of claim 1, wherein said global positioning system signal receiving and processing circuit comprises:
a first antenna, for receiving said global positioning system signal;
a radio frequency circuit of said global positioning system signal, coupled to said first antenna for receiving said global positioning system signal transmitted from said first antenna, and amplifying, down-converting and digitizing said global positioning system signal;
a base band processor of said global positioning system, coupled to a radio frequency circuit of said global positioning system signal for receiving a signal transmitted from said radio frequency circuit of said global positioning system signal, and then sending said signal to said microprocessor after said signal is de-spread and synchronized.

3. The receiver of claim 1, wherein said frequency modulation sub-wave signal receiving and processing circuit comprises:
a second antenna, for receiving said frequency modulation sub-wave signal;
a frequency modulation tuner, coupled to said second antenna for receiving and demodulating said frequency modulation sub-wave signal transmitted from said second antenna;
a preprocessor, coupled to said frequency modulation tuner for receiving a signal transmitted from said frequency modulation tuner, and sending said signal to said microprocessor after synchronizing a data carried by said preprocessor.

4. The receiver of claim 2, wherein said frequency modulation sub-wave signal receiving and processing circuit comprises:
a second antenna, for receiving said frequency modulation sub-wave signal;
a frequency modulation tuner, coupled to said second antenna for receiving and demodulating said frequency modulation sub-wave signal transmitted from said second antenna;
a preprocessor, coupled to said frequency modulation tuner for receiving a signal transmitted from said frequency modulation tuner, and sending said signal to said microprocessor after synchronizing a data carried by said preprocessor.

5. The receiver of claim 3, wherein said hardware interface comprises a hardware interface for a cable transmission or a wireless transmission.

6. The receiver of claim 4, wherein said frequency modulation sub-wave signal is a frequency modulation sub-wave signal having a center frequency of 57 KHz and a bandwidth of 4 KHz.

7. The receiver of claim 5, further comprising at least one memory coupled to said microprocessor for storing a program required for said microprocessor to compute a positioning coordinate of said global positioning system signal and a coding rule required for said microprocessor to resolve a data in said frequency modulation sub-wave, and said microprocessor completes a computation and a resolution of said positioning coordinate data and said traffic message channel data by executing and reading said program and said coding rule.

8. The receiver of claim 6, wherein said coding rule comprises a traffic information and its corresponding codes related to an event, a place, a start time, a stop time, an average speed, an affected length, and a diverse advise route in said traffic message channel data.

9. The receiver of claim 5, wherein said microprocessor integrates said positioning coordinate data and said traffic message channel data into a text string, and then sends out said signals.

10. The receiver of claim 8, wherein said microprocessor sends out said text string in ASCII specification.
